(19) United States
(12) Patent Application Publication
(10) Pub. No.: US 2020/0365911 A1
(43) Pub. Date: Nov. 19, 2020

(54) Method to Make Isostructural Bilayer Oxygen Electrode

(71) Applicant: UNIVERSITY OF SOUTH CAROLINA, COLUMBIA, SC (US)

(72) Inventor: KEVIN HUANG, COLUMBIA, SC (US)

(21) Appl. No.: 16/802,608

(22) Filed: Feb. 27, 2020

Related U.S. Application Data
(60) Provisional application No. 62/848,110, filed on May 15, 2019.
(60) Provisional application No. 62/899,887, filed on Sep. 13, 2019.

(51) Int. Cl. H01M 4/88; H01M 4/90

(52) U.S. Cl. CPC H01M 4/8885; H01M 4/9033; H01M 4/8828

(57) ABSTRACT

In general, the present disclosure is directed to methods to produce stable oxygen electrodes for use in energy storage applications such as fuel cells. Aspects of the disclosure can provide improved stability, especially for oxygen electrodes including strontium, which can broaden applications and reduce costs to improve economic feasibility. Embodiments of the disclosure can include methods for producing oxygen electrodes, compositions of stabilizing coatings that can be applied to electrodes to yield a more stable oxygen electrode, and fuel cells incorporating oxygen electrodes produced according to the disclosure. In particular, the disclosure is directed to a finding that a conformal coating can be achieved by calcining a composition including a strontium salt, a cobalt salt, and a tantalum compound on a base electrode, the base electrode having an elemental composition including strontium.

### CROSS REFERENCE TO RELATED APPLICATIONS

This application claims priority to U.S. Provisional Application Nos. 62/848,110, filed May 15, 2019, and 62/899,887, filed Sep. 13, 2019, both of which are incorporated herein in their entirety by reference.

### STATEMENT AS TO RIGHTS TO INVENTIONS MADE UNDER FEDERALLY SPONSORED RESEARCH

This invention was made with Government support under Contract No. DE-FE0031671, awarded by the U.S. Department of Energy (DOE). The Government has certain rights in the invention.

### BACKGROUND

The commercial development of solid oxide fuel cell (SOFC) technology in recent decades has primarily focused on how to lower the working temperature so that cost and reliability of SOFC can both be improved to meet the targets for practical applications, while still maintaining reasonable performance. The current benchmark oxygen electrode, in general, has an insufficient rate of kinetics towards oxygen reduction reaction (ORR) to yield a low enough polarization resistance in a reduced temperature range. A representative of the first-generation benchmark oxygen electrode is La₁₋ₓSrₓMnO_{3-δ} (LSM), a pure electronic conductor that confines its ORR to triple-phase (air/oxygen electrode/electrolyte) boundaries (3PBs); this limitation has narrowed the application of LSM-based oxygen electrodes to 900-1000° C.

Replacement of LSM with mixed ionic and electronic conductors (MIECs) extends the ORR-active sites from 3PBs to air/oxygen electrode two-phase boundaries (2PBs), thus significantly increasing reactive areas and ORR-kinetics. Representatives of this second-generation benchmark oxygen electrode are oxygen-deficient perovskites such as (Sm,Sr)CoO_{3-δ}, (Ba,Sr)(Co,Fe)O_{3-δ}, and (La,Sr)(Co,Fe)O_{3-δ}, just to name a few. Due to its high intrinsic ORR-activity, this class of oxygen electrodes is more suited for applications in intermediate-temperature SOFCs (IT-SOFCs). However, the high ORR activity of these materials is commonly accompanied by a much higher thermal expansion coefficient (TEC) than that of the electrolyte (e.g., 15-20 vs 10 ppm/K), making them a direct use of bulk oxygen electrode in IT-SOFCs impossible. To avoid the TEC problem, while still utilizing the high ORR activity, these materials are often used in a form of nanoparticles (NPs) anchored on a TEC-compatible skeleton. At elevated temperatures, however, NPs are prone to sinter, resulting in performance degradation.

It is also interesting to note that many ORR-active perovskites use Sr (or other alkaline earth elements) as a dopant to increase electronic conductivity and oxygen vacancy concentration. One critical issue with these Sr-doped perovskites (SDPs), such as La_{0.6}Sr_{0.4}Co_{0.2}Fe_{0.8}O_{3-δ} (LSCF) and La_{0.6}Sr_{0.4}CoO_{3-δ} (LSCo), is the Sr segregation originated from the electrostatic interaction between dopant (Sr′_{Lα}) and oxygen vacancy (Vₒ^{••}), another cause for performance degradation.

Still needed in the art are coarsening-resistant and Sr-segregation-free, yet highly active, oxygen electrodes for IT-SOFCs.

### SUMMARY

Reducing the resistances of oxygen reduction reaction (ORR) and oxygen evolution reaction (OER) while retaining the stability of an oxygen electrode (OE), even in the presence of air contaminants such as Cr, H₂O and CO₂, is important for success of intermediate temperature-reversible solid oxide cells (IT-RSOCs). One of the challenges to the commercialization of metal-interconnect loaded IT-SOC stacks is the unacceptable degradation rate caused by Cr (a rich element in the interconnect) volatilization and subsequent condensation on OE, blocking ORR/OER actives, a phenomenon commonly known as Cr-poisoning. This disclosure is directed to embodiments which demonstrate Cr-tolerant and coarsening-resistant stability, while also providing an ORR/OER-active OE that can be used in application, such as IT-RSOCs. Example OEs according to the disclosure can feature a bilayer structure with an ORR/OER-active perovskite having a composition such as SrCoTaO (SCT10) as the capping layer and a commercial perovskite such as (La_{0.6}Sr_{0.4})_{0.95}Co_{0.2}Fe_{0.8}O_{3-δ}(LSCF)-Ce_{0.8}Gd_{0.2}O_{1.9} (GDC) composite as the underlayer skeleton.

In general, disclosed herein are methods for producing the OE, compositions of the capping layer, and fuel cells including an oxygen electrode having a bilayer structure. Results for certain embodiments can demonstrate advantages such as improved activity and stability compared to single-layer LSCF-GDC.

### BRIEF DESCRIPTION OF THE FIGURES

A full and enabling disclosure of the present invention, including the best mode thereof to one skilled in the art, is set forth more particularly in the remainder of the specification, which includes reference to the accompanying Drawings, in which:

FIG. 1 illustrates a graph displaying XRD patterns of solution-derived samples calcined at different temperatures.

FIG. 2 illustrates a scanning transmission electron microscope (STEM) image in the upper left along with elemental mapping over the same image for La, Fe, Ta, Co, and Sr.

FIG. 3 illustrates a scanning electron microscope image (left) along with inlays displaying selected area electron diffraction (SAED) for areas 1 (top right) and 2 (bottom right).

FIG. 4A illustrates a STEM image of an example embodiment in accordance with the disclosure.

FIG. 4B illustrates the elemental composition of a selected region as shown in FIG. 4A. A dashed line displays an approximate interface between an LSCF region and an SCT10 region.

FIG. 5 illustrates a comparative example showing surface morphologies at low temperature calcining (800° C.) and high temperature calcining (1000° C.). Also shown are representative SEM images of example oxygen electrodes produced using the conditions depicted.

FIG. 6A illustrates a graph displaying oxygen electrode polarization resistance R_{P} versus time.

FIGS. 6B and 6C illustrate surface morphology (left) and elemental mapping (right) of example pristine and bilayer oxygen electrodes, respectively.

FIGS. 7A-7D illustrate graphs displaying impedance measurements of example pristine and bilayer oxygen electrodes at varying temperatures.

FIG. 7E illustrates a graph comparing impedance at varying temperature in the presence of 0.5% CO₂ or 1% CO₂.

FIGS. 8A-8D illustrate graphs displaying imlpedance measurements of example pristine and bilayer oxygen electrodes at varying temperatures.

FIG. 8E illustrates a graph comparing impedance at varying temperature in the presence of 2.3% H₂O or 5.5% H₂O.

FIG. 9 illustrates a graph displaying example impedance measurements of example pristine and bilayer oxygen electrodes.

FIGS. 10A-10B depict images of example pristine oxygen electrodes after (10A) and before (10B) testing.

FIGS. 10C-10D depict images of example bilayer oxygen electrodes after (10C) and before (10D) testing.

FIGS. 11A-11D depict images and data comparing pristine oxygen electrodes (11A and 11B) and example bilayer oxygen electrodes (11C and 11D).

FIG. 12 depicts an illustration of example reactions that can occur in example pristine oxygen electrode (a) and example bilayer oxygen electrode (b) on exposure to H₂O, CO₂, or CrO₃.

FIG. 13 illustrates an example electrochemical station for determining attributes of example oxygen electrodes according to the present disclosure.

FIGS. 14A-14B depict graphs comparing aspects of an example pristine oxygen electrode (14A) and an example bilayer oxygen electrode (14B).

Repeat use of reference characters in the present specification and drawings is intended to represent the same or analogous features or elements of the present invention.

### DETAILED DESCRIPTION

Reference now will be made to embodiments of the invention, one or more examples of which are set forth below. Each example is provided by way of an explanation of the invention, not as a limitation of the invention. In fact, it will be apparent to those skilled in the art that various modifications and variations can be made in the invention without departing from the scope or spirit of the invention. For instance, features illustrated or described as one embodiment can be used on another embodiment to yield still a further embodiment. Thus, it is intended that the present invention cover such modifications and variations as come within the scope of the appended claims and their equivalents. It is to be understood by one of ordinary skill in the art that the present discussion is a description of exemplary embodiments only and is not intended as limiting the broader aspects of the present invention, which broader aspects are embodied exemplary constructions.

The present disclosure is directed to compositions and structures for fuel cell oxygen electrodes that can provide improved stability, especially for oxygen electrodes (OEs) including strontium as a dopant. Embodiments of the disclosure can include methods for producing oxygen electrodes, compositions of stabilizing coatings that can be applied to electrodes to produce a more stable oxygen electrode, as well as fuel cells incorporating oxygen electrodes produced according to example implementations of the disclosure. In addition to improved stability, some embodiments may demonstrate increased reactivity, such as displaying lower resistance after a period of use and/or at an applied current when compared to non-bilayer materials. Such bifunctional materials may provide significant advancements in developing fuel cells for applications in large scale (e.g., grid) energy storage by decreasing costs for replacing or reactivating fuel cell components such as the oxygen electrode.

In particular, the disclosure is directed to a finding that a conformal coating can be produced by calcining a composition including a strontium salt, a cobalt salt, and a tantalum compound on a base electrode, the base electrode having an elemental composition including strontium. Without subscribing to one specific theory, it is hypothesized that this coating can reduce segregation of strontium oxide at the electrode surface, which can result in deactivation. Thus, methods of the disclosure can be applied to produce a stable bilayer oxygen electrode without diminishing reactivity. Further, certain embodiments may demonstrate higher reactivity (e.g., lower impedance or resistance values) compared to standard materials such as a monolayer oxygen electrode. Thus, embodiments of the disclosure represent an improvement in oxygen electrode materials, especially for oxygen electrodes which include strontium as a dopant.

An example embodiment of the disclosure includes a method of forming a fuel cell oxygen electrode. In general, the method includes preparing a solution containing a strontium salt, a cobalt salt, and a tantalum compound. The solution may be stabilized by the addition of one or more buffers and/or a chelating agent to improve solubility of the metals in solution. After preparing the solution, a portion can be applied to a base electrode. As described, certain embodiments may provide additional advantages for stabilizing base electrodes including strontium, though other chemically reactive electrode materials may also benefit from the coatings and methods of producing oxygen electrodes as disclosed herein. The base electrode having the solution applied to it is then calcined at a temperature of about 900° C. to about 1500° C. Interestingly, it was found that a morphology transition occurs in this regime. Calcining at lower temperatures led to particles forming on the electrode surface rather than producing a conformal coating from the metal salts included in the solution. Thus, lower temperatures (e.g., temperatures less than about 900° C.) may not display the advantages of improved stability displayed in certain embodiments of the disclosure.

In some implementations, preparing the solution including the strontium salt, the cobalt salt, and the tantalum compound can include a multi-step procedure. Due to varying solubilities, it can be advantageous to prepare a first solution (e.g., an aqueous solution) containing the strontium salt, the cobalt salt, and water. A second solution (e.g., a nonaqueous solution) can be prepared separately including the tantalum compound. These solutions may each be separately buffered and/or include different solvents (e.g., one solution can be aqueous being primarily composed of water, and the other solution can be nonaqueous being primarily composed of an organic solvent). Additional stabilizers such as salts, chelators, or other chemical agents may also be included in each solution. Combining the two solutions can then produce the solution for application to the base electrode. An example aspect of combining the two solutions may include a rate of addition. For example, to prevent precipitation or other forms of phase separation, the solutions can be combined at a certain rate (e.g., dropwise) or may be combined at a temperature (e.g., 50° C. to 80° C.) to improve solubility.

For certain embodiments, it may be desired to prevent incorporation of other metals in the electrode coating. Thus, for some implementations, the solution and/or any added salts or buffers may not include an additional metal cation (e.g., group 1 elements such as Na and K and/or group 2 elements such as Mg and Ca) other than strontium, cobalt, or tantalum. In these implementations, an amine or ammonium salt (e.g., ammonium hydroxide, ammonium carbonate, glycine, etc.) may be used to adjust the pH. Additionally, a chelating agent such as ethylenediaminetetraacetic acid (EDTA) can be included.

An example aspect of the base electrode can include a structure incorporating one or more materials. For example, the base electrode can include a support made from a material such as a ceramic electrolyte (e.g., a gadolinia-doped ceria or an yttria-doped zirconia). The ceramic electrolyte can act as a support for depositing an overcoat that will be in contact with the electrode coating. For some implementations, combinations of ceramic electrolytes can be used as a suitable support material. Thus, certain embodiments can include a fuel cell oxygen electrode formed from a support having an overcoat covering a region (e.g., about 25% to about 100% of the surface) of the support, and an electrode coating that substantially covers the overcoat and/or any regions of the support not covered by the overcoat. Another example aspect of the overcoat can include a porosity. For certain methods of forming a fuel cell oxygen electrode, according to the disclosure, applying a portion of the solution to the base electrode can include applying the solution to one or more areas of the porous overcoat to wet the entirety of the overcoat prior to calcining the base electrode. Further, in some implementations, applying the solution to the porous overcoat and calcining the base electrode may be repeated to ensure production of a conformal coating over most (e.g., 25% or greater) of the base electrode and/or overcoat surface. Alternatively, or additionally, the solution can be applied using an immersion technique where the porous overcoat may be completely submerged in the solution.

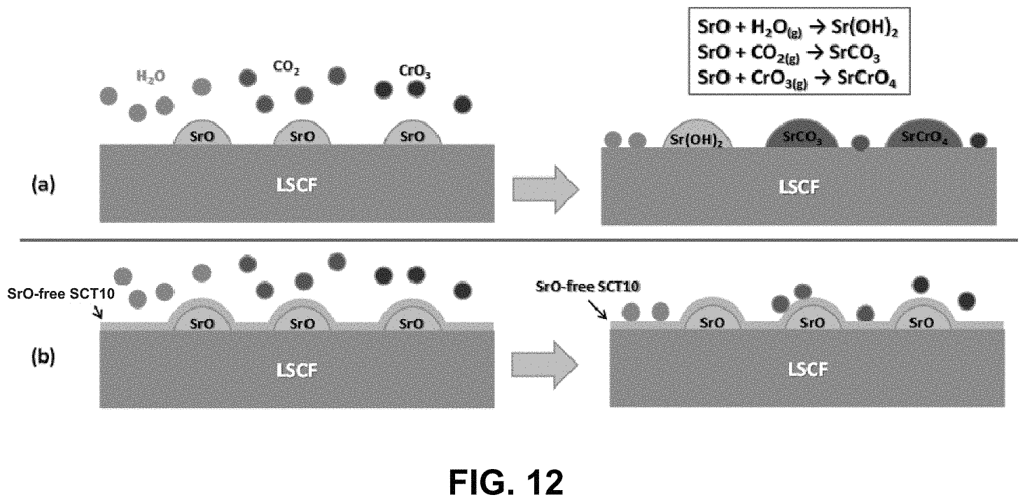

For embodiments of the disclosure, the base electrode can comprise an elemental composition including strontium. Additionally, or alternatively, the base electrode can include one or more of lanthanum, cobalt, and iron. In some implementations, the strontium may only be included in the overcoat. As an example, for illustration, the overcoat can include an elemental composition of LaSrCoFeO, for which an example material can include the empirical formula La_{0.6}Sr_{0.4}Co_{0.2}Fe_{0.8}O_{3-δ}. While various arrangements and materials may be used to produce the fuel cell oxygen electrodes according to the disclosure, additional benefits may be realized when using a base electrode containing at least lanthanum (La) and strontium (Sr). For these materials, segregation/and or phase separation of metals under operating conditions can lead to deactivation. For instance, without intending to be bound by one particular theory, strontium oxide may phase separate under certain conditions to surface regions of the base electrode (e.g., an oxygen electrode not having a bilayer structure) which may lead to deactivation. FIG. 12 illustrates an example of this deactivation where SrO at the surface may react with water, carbon dioxide, or Cr (in the form of chromium trioxide) to yield an inactive or less active form of the oxygen electrode.

Another example aspect of methods of forming a fuel cell oxygen electrode can include a calcining temperature. For embodiments of the disclosure, the calcining temperature is generally between about 900° C. to about 1500° C. In some implementations, the temperature can be about 950° C. to about 1500° C., such as about 975° C. to about 1250° C., or about 990° C. to about 1100° C.

Without intending to limit the scope of materials that can be used to produce the solution, an example of the strontium salt can include Sr(NO₃)₂, an example of the cobalt salt can include Co(NO₃)₂.6H₂O, and an example of the tantalum compound can include Ta(OC₂H₅)₅. Thus, while exemplified as nitrate salts and an alkoxide, it should be understood that variations such as halide salts, phosphate salts, hydrates, and other common stable anions or coordinating groups may be utilized in combination with strontium, cobalt, and tantalum cations to produce a strontium salt, a cobalt salt, and a tantalum compound in accordance with the present disclosure.

For certain embodiments, the method of forming a fuel cell oxygen electrode can also include creating the base electrode by applying the overcoat to the substrate. As an example, applying the overcoat can be accomplished using screen printing or other suitable techniques for depositing the overcoat on the substrate. In some instances, suitable deposition techniques may be limited to only those which can produce a porous overcoat.

In general, methods described herein may be used to produce a stable or stabilizing electrode coating. Aspects of the electrode coating can include a composition comprising the elements: Sr, Co, Ta, and O (SrCoTaO). For certain embodiments, the electrode coating may be further described by the empirical formula SrCo_{0.9}Ta_{0.1}O_{3-δ}. The empirical formula defines the elemental composition with respect to one another. As shown in the empirical formula, in certain embodiments, there can exist an oxygen deficiency (δ) which can range from 0-0.5.

Embodiments of the disclosure can also include a composition for an electrode coating. The electrode coating may be present on a base electrode, such as an electrode including strontium. Additionally, embodiments of the disclosure can include a fuel cell incorporating the fuel cell oxygen electrode produced by any of the methods described or having an electrode including an electrode coating as described herein.

While exemplified throughout the present disclosure as a tantalum compound, it should be understood that other related metals, such as group 5 transition metals, may be substituted for or used in combination with the tantalum compound. For instance, niobium (Nb) is generally recognized as similar to tantalum and is also a group 5 transition metal. Thus, in some embodiments, a niobium compound may be included in the solution as part of the method for forming the oxygen electrode. Additionally, for certain embodiments, niobium can be substituted for tantalum or included as part of a composition for an electrode coating.

Aspects of the present disclosure can provide advantages for oxygen electrodes or other electrodes that may be exposed to contaminates, such as chromium, water, carbon dioxide or other chemical species. Further, the bilayer isostructure can demonstrate improved efficiency for reactions such as oxygen evolution reaction (OER) and/or oxygen reduction reaction (ORR) by reducing resistance (Rₚ)—in some cases by an order of magnitude (10×)—when compared to pristine or non-bilayer materials. For example, in some implementations according to the present disclosure, a bilayer oxygen electrode may display an impedance of less than about 0.5 Ωcm², such as less than about 0.40, 0.35, or 0.30 after about 2000 hours of use. Further exemplary properties can be understood with reference to the FIGs. and in the following Example 1.

These and other modifications and variations to the present invention may be practiced by those of ordinary skill in the art, without departing from the spirit and scope of the present invention, which is more particularly set forth in the appended claims. In addition, it should be understood the aspects of the various embodiments may be interchanged both in whole or in part. Furthermore, those of ordinary skill in the art will appreciate that the foregoing description is by way of example only and is not intended to limit the invention further described in the appended claims.

### EXAMPLE 1

Example 1 discusses various methods and provides exemplary embodiments that may be understood in conjunction with the Drawings and Description provided herein. The materials and conditions described in the example are demonstrative and are not meant to constrain the scope of the disclosure only to the materials and conditions used.

### MATERIALS AND METHODS

Preparation of SCT10 precursor solution

To make the SCT10@LSCF bilayer structure, we first used an aqueous solution containing Sr, Co, and Ta as the precursor and infiltrated it into a prefabricated porous LSCF skeleton. To make the SCT10 precursor solution, citric acid (Sigma-Aldrich) was first dissolved in de-ionized water, followed by adding a stoichiometric amount of Sr(NO₃)₂ (Alfa Aesar) and Co(NO₃)₂.6H₂O (Alfa Aesar) under stirring. A separate solution containing ethylene diamine tetraacetic acid (EDTA, Sigma-Aldrich) dissolved in a diluted ammonia water was then mixed with the above solution with a targeted pH of 8. A stoichiometric amount of Ta(OC₂H₅)₅ (Sigma-Aldrich) dissolved into a pure ethanol was then slowly added into the above solution to complete the solution preparation. In the final solution, the total metal-ions concentration was 0.2 M with a molar ratio of citric acid to EDTA to metal ions at 2:1:1 and a volumetric ratio of de-ionized water to ethanol ratio at 5:1.

To determine the right temperature for post-infiltration calcination to form single-phase SCT10, a portion of the above solution was collected, dried at 80° C., and then ignited at 500° C. for 1 hour. The resulting powder was then fired at 800° C., 900° C., and 1000° C. for 2 hours, respectively. In addition to the pure phase formation, it was also shown that strong evidence that calcining SCT precursor at higher temperatures also favors the formation of a continuous and conformal thin film over the LSCF skeleton. This finding is somewhat different from those early studies in which only a transitional state of discrete NPs to continuous film on the skeleton was observed as the calcination temperature was increased.

Fabrication of SCOT10@LSCF bilayer and symmetrical cells

The symmetrical cell was first fabricated by screen printing an LSCF ink (purchased from fuelcellmaterials) on both sides of a 500-μm thick Gd_{0.2}Ce_{0.8}O_{2-δ} (GDC20, fuelcellmaterials) dense pellet, followed by firing at 1100° C. for 2 hours. Thus-fabricated electrode is porous and has an effective electrode geometric area of 1.27 cm² and a thickness of ca. 40 μm. A 10 μL of SCT10 solution was then applied dropwise into each side of the porous LSCF skeleton for each cycle of infiltration, followed by thermal treatment at 80° C. and 500° C. for 1 hour each, respectively. The rate of SCT10 loading was 2% per infiltration cycle. The infiltrated samples were finally fired at 1000° C. for 2 hours to form a pure SCT10 phase and thin layer that covers completely the surface of LSCF skeleton at 20 wt % loading level (relative to LSCF). For all electrochemical testing, gold paste (c8829a, Heraeus) and silver mesh were attached as current collectors to both sides of the electrode and cured at 600° C. for 1 hour before use.

### Electrochemical Impedance Spectroscopy (EIS)

The EIS spectra of symmetrical cells were collected with a Solartron 1470/1455B electrochemical station in a frequency range of 0.01 Hz-1 MHz and AC amplitude of 10 mV. The collected EIS spectra were analyzed with equivalent circuit method by ZSimpWin software to extract the polarization resistance of interest.

The effects of air contaminants were studied using EIS on symmetrical cell configuration. The Cr-study was carried out using ferritic stainless steel 430 as the source of Cr at the upstream of a flowing air. Similarly, the effects of H₂O and CO₂ on the oxygen electrode polarization resistance were also studied with EIS of symmetrical cell. During H₂O/CO₂ concentration variations, the cell temperature was changed from 550° C. to 700° C. and gas concentrations of H₂O and CO₂ were varied from 0 to 3%.

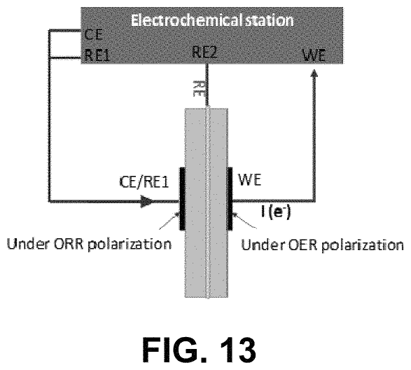

To study the effect of a load current on RP, a symmetrical three-electrode half-cell was designed, knowing that the original symmetrical cell would no longer be symmetrical anymore once a DC current passes through the two electrodes, i.e., one electrode performs OER while another performs ORR. The functionality of the reference electrode is to enable EIS measurement at a specific electrode. FIG. 13 shows the schematic of the cell configuration aiming to measure R_{P} of the electrode under OER polarization. With this method, R_{P} for ORR and OER processes can be separated under DC polarization.

Microstructure and phases characterization

The microstructures of electrodes were generally characterized by a field emission scanning electron microscope (FESEM, Zeiss UltraPlus). To observe the cross-section of the bilayer structure, Focused Ion Beam (FIB, Hitachi NB-5000) technique was used to prepare samples and transmission electron microscope (TEM) imaging (Hitachi H-9500), selected area electron diffraction (SAED), and scanning transmission electron microscope (STEM, Hitachi HD-2000) imaging equipped with energy-disperse x-ray spectroscopy (EDX) were employed to obtain images, determine crystal structure, as well as to analyze chemical compositions. The resolutions for STEM-EDX are 0.8, 0.5, and 0.3 nm for spot, line-scan, and mapping modes, respectively. To analyze surface chemistry, particularly Sr-concentration, of oxygen electrode, X-ray photoelectron spectroscopy (XPS) (Kratos AXIS Ultra DLD XPS) was performed. To ensure the accuracy, the binding energy (BE) was calibrated by the C-1s photoemission peak at 284.6 eV.

The phase composition of the prepared powder sample was examined with an X-ray diffractometer (MiniFlex™, Rigaku, Japan) equipped with Cu Kα radiation (λ=1.5418 Å) over a 2θ=10-90° range in a step size of 0.02° at a scanning rate of 5° min⁻¹.

### RESULTS

Phase evolution of SCT10 with calcination temperature

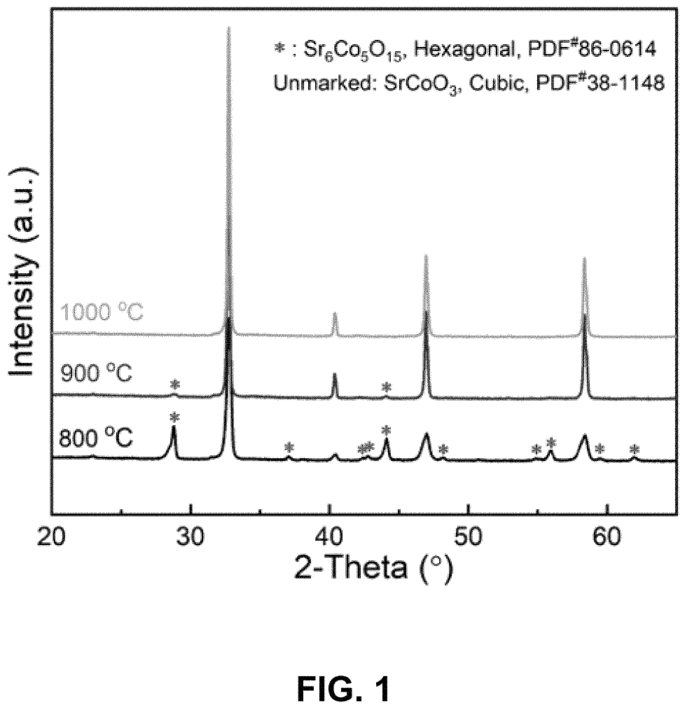

The phase compositions of SCT10 calcined at different temperatures are shown in FIG. 1 of XRD patterns. Evidently, in the range of about 900° C. to about 1000° C., a transition occurs for the formation of a pure SCT10 phase, below which the hexagonal phase of Sr₆Co₅O₁₅ is observed among the cubic perovskite structure. It appears the lower the calcination temperature, the more Sr₆Co₅O₁₅.

The microstructure and compositional distribution of SCT10@LSCF oxygen electrode

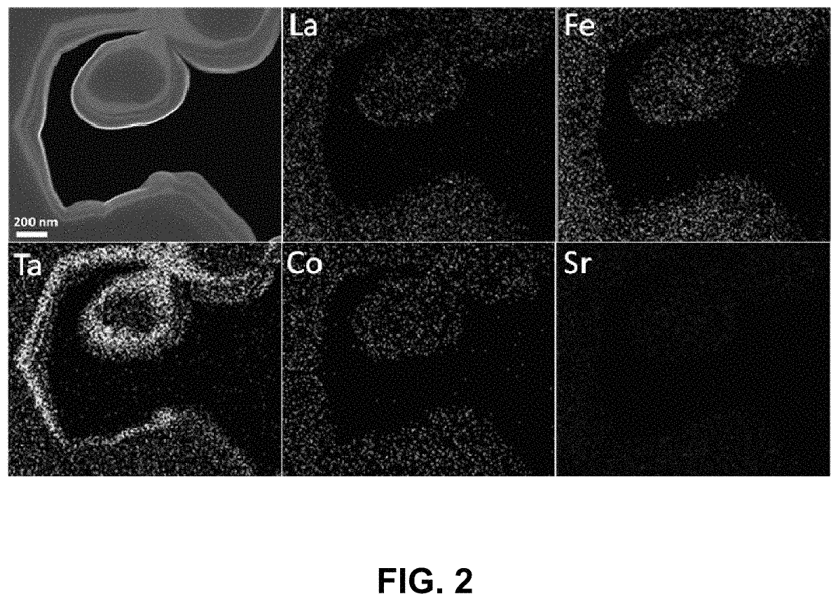

The STEM image of SCT10 infiltrated LSCF (collectively denoted as SCT10@LSCF) of FIG. 2 clearly reveals a continuous, intimately-bonded bilayer structure. The observation of continuous bilayer structure is different from conventional, widely reported, discrete nanoparticles (NPs) morphology produced by infiltration method. Two factors that may contribute to the continuous bilayer structure are calcination temperature and structural similarity between the two layers.

The compositional analysis by STEM-EDX indicates that Ta from SCT10 mostly concentrates in the outer layer, suggesting that it is likely the infiltrated SCT10. Meanwhile, it appears that Fe and La are also in the SCT10 outer layer, implying that some degree of cation-interdiffusions between SCF10 and LSCF may also take place during the 1000° C. calcination.

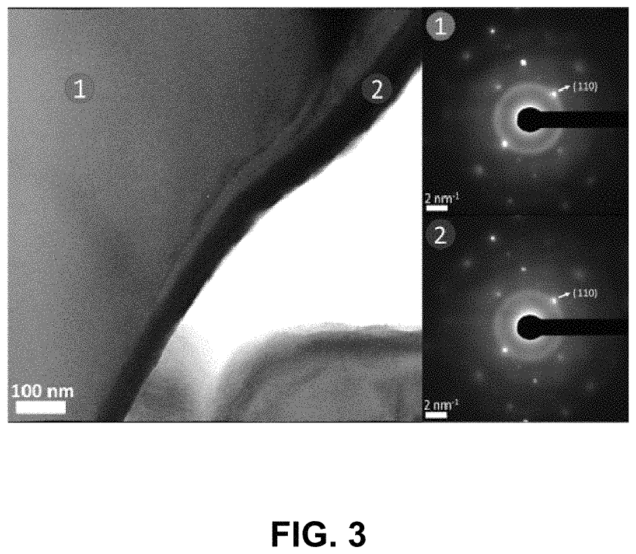

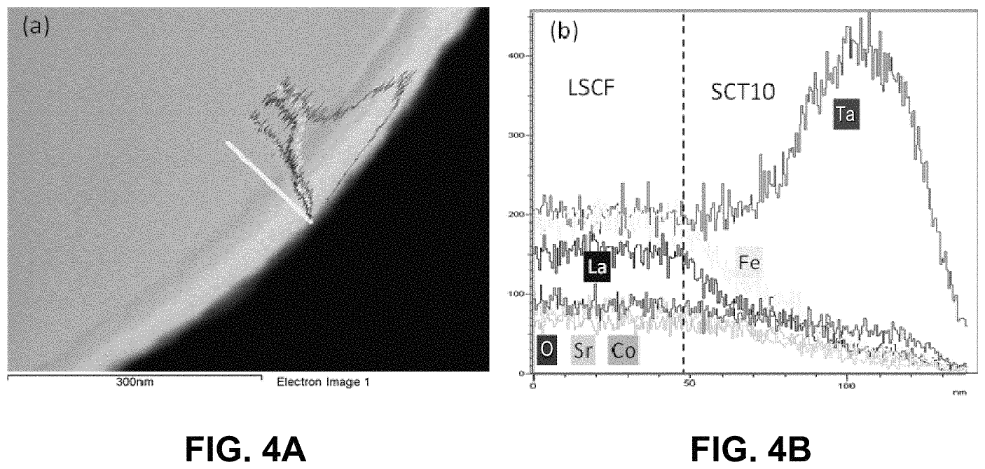

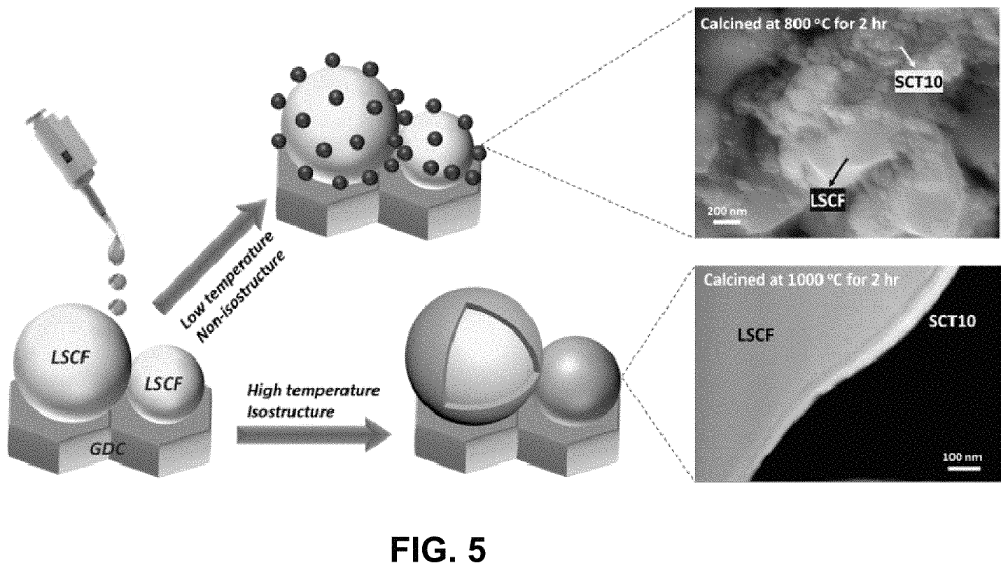

The crystal structures and composition of the bilayer were further analyzed by SAED and STEM-EDX, respectively, the results in FIGS. 3 and 4. FIG. 3 showing TEM images and SAED patterns of as-prepared SCT10@LSCF-GDC; the numbers denote the center of electron beam area for SAED. The diffraction patterns indicate that SCT10 and LSCF have an iso-structure with identical (110) d-spacings (0.28 nm). This is not unexpectedly surprising since both SCT10 and LSCF are perovskites with corner-shared 3d metal-oxygen octahedra. However, the same d-spacing seems to suggest that cation interdiffusions between SCT10 and LSCF may play a role in chemical homogenization (except for Ta) shown in both FIGS. 2 and 4. FIGS. 4A and 4B show the STEM image and line scanning results, respectively, near the interface of SCT10-outer layer and LSCF-GDC-underlayer. Nevertheless, the more active SCT10 outer layer is expected to provide high ORR-activity, while the porous LSCF underlayer is anticipated to provide pathways for electron/ion conduction, gas transport, and structural support.

Formation of continuous SCT10@LSCF bilayer structure

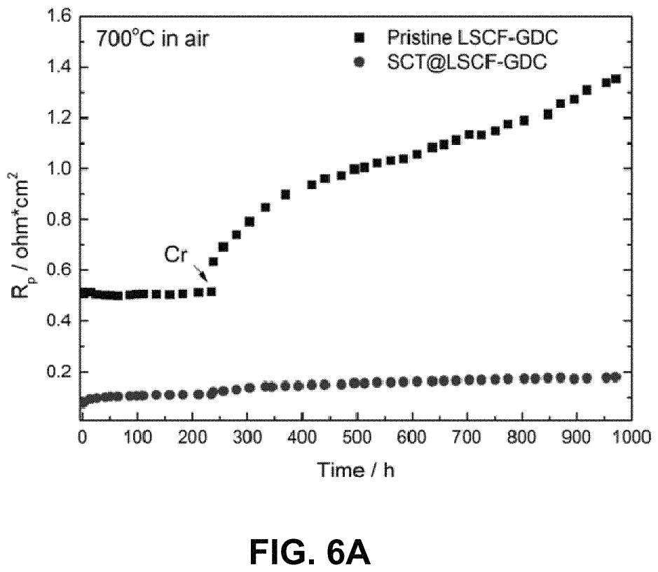

Formation of continuous bilayer iso-structure between SCT10 and LSCF is a unique phenomenon observed by this study. Some early studies have shown that the morphology of infiltrants can depend upon the calcination temperature. For example, other researchers have reported a discrete NP morphology when calcining the isostructural Sm_{0.5}Sr_{0.5}O_{3-δ} infiltrant on La_{0.6}Sr_{0.4}Co_{0.2}Fe_{0.8}O_{3-δ} skeleton at 800° C. Similar morphologies for SCT10@LSCF were observed in this work when calcinating the sample at 800° C. for 2 hours (see the inset of FIG. 5). At higher calcination temperatures, such as ≥900° C., a transitional discrete-to-continuous layer of NPs was observed in non-isostructures (fluorite/perovskite), such as LSCF@GDC calcined at 1200° C., (Sm, Ce)-doped SrCoO_{3-δ}@ Sm_{0.2}Ce_{0.8}O_{1.9} at 1100° C., and LaNi_{0.6}FeO_{3-δ}@ YSZ (yttria-stabilized zirconia) at 1100° C. However, no iso-structural, continuous bilayer structure such as SCT10@LSCF observed in this study has been previously reported. To facilitate the understanding of temperature-morphology relationship, FIG. 5 provides a drawing depicting the formation of discrete NPs and continuous layer of SCT10 on LSCF at low- and high-temperature regimes, respectively, in accordance with experimental observation.

Effects of Cr, H₂O and CO₂ on SCT10@LSCF performance

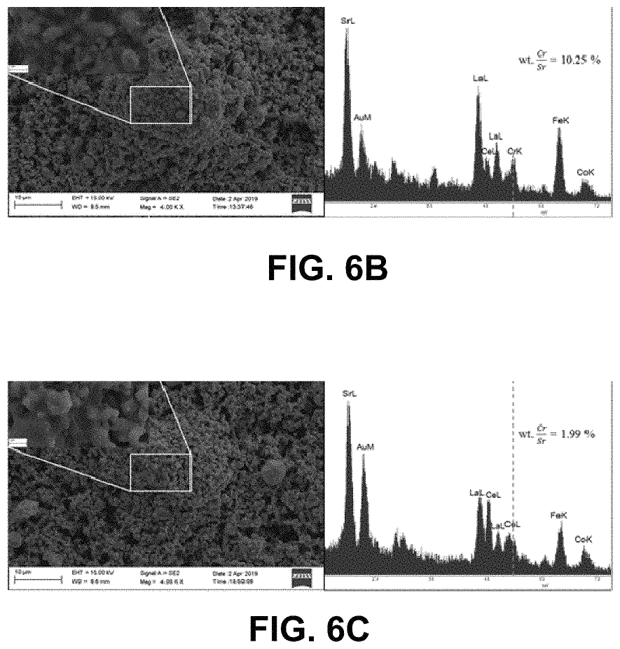

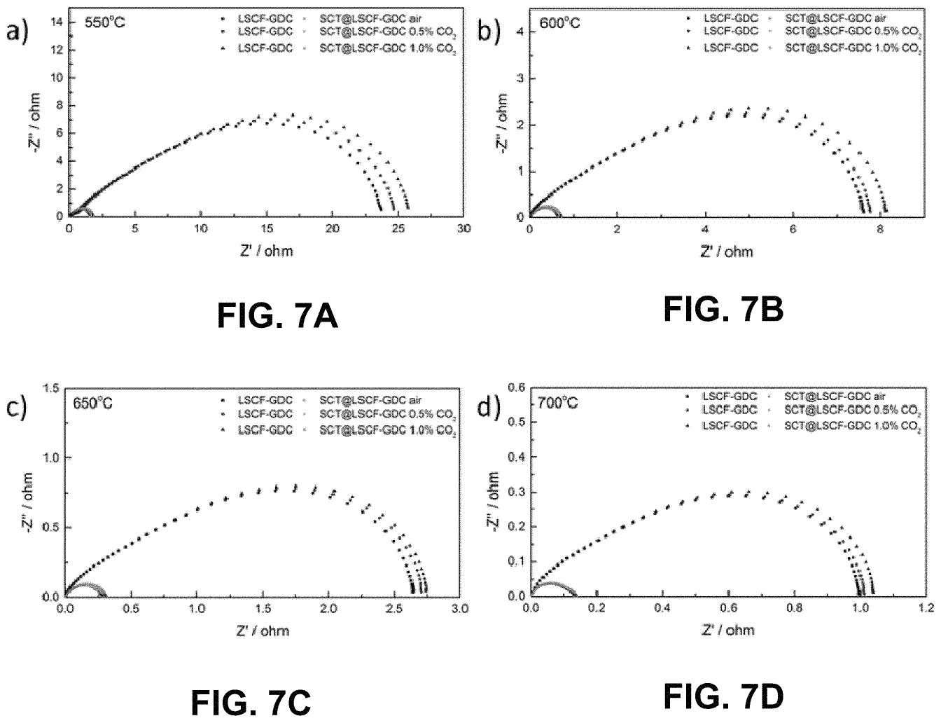

FIG. 6A shows polarization resistance change vs time of the pristine and new bilayer oxygen electrode. As soon as Cr is added into the cell, the pristine oxygen electrode exhibits a fast increase in Rp, whereas the new bilayer oxygen electrode shows stable Rp, demonstrating its Cr-resistance. FIGS. 6B and 6C further support the Cr-resistance by showing less Cr on the surface of the bilayer oxygen electrode (6C) compared to the pristine oxygen electrode (6B).

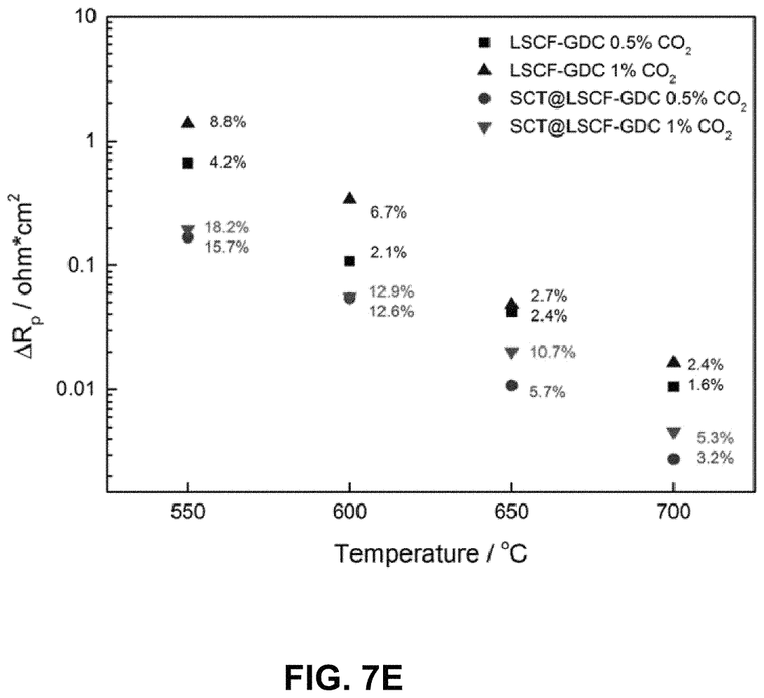

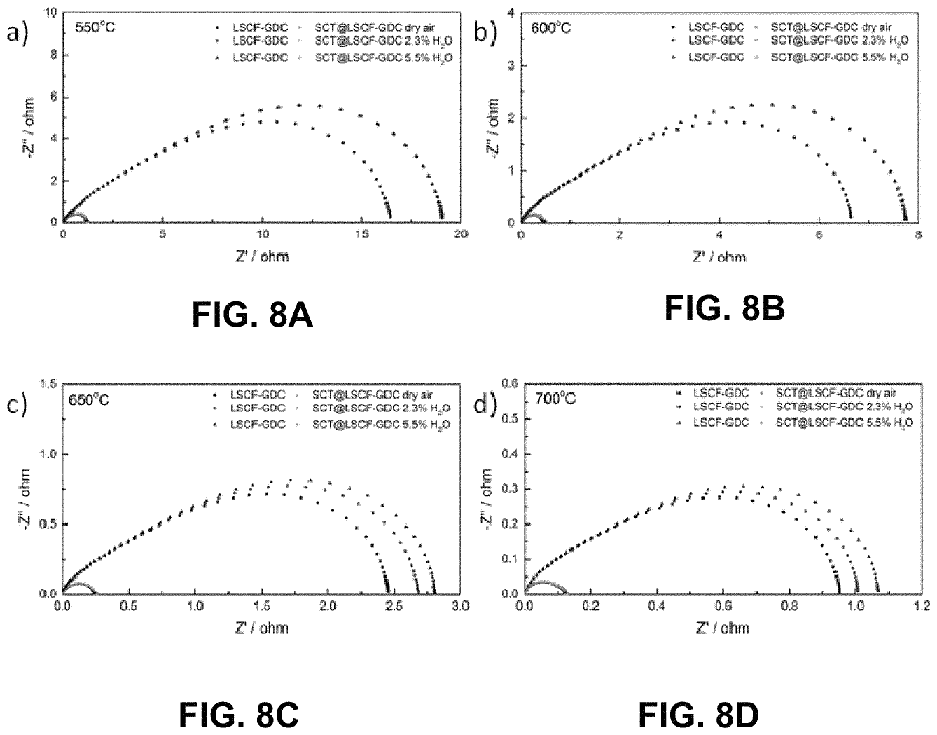

FIGS. 7A-7E show the effect of CO₂ on Rp of both pristine and bilayer oxygen electrodes. In general, the bilayer oxygen electrode (SCT@LSCF-GDC) has a better tolerance to CO₂. FIGS. 7A-7D illustrate data obtained, respectively, at 550° C., 600° C., 650° C., and 700° C. FIG. 7E summarizes this data to show change of Rp vs temperature after being exposed to CO₂-containing air.

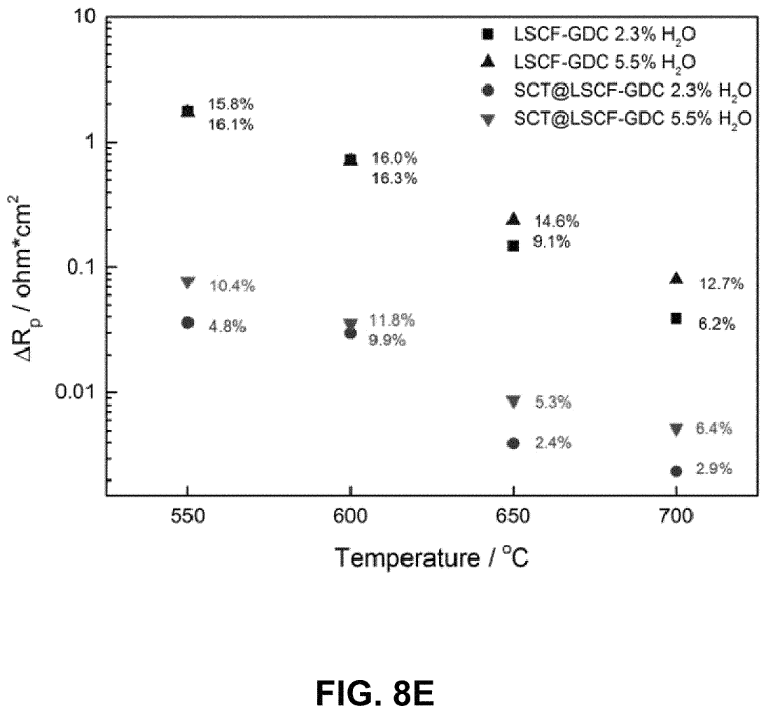

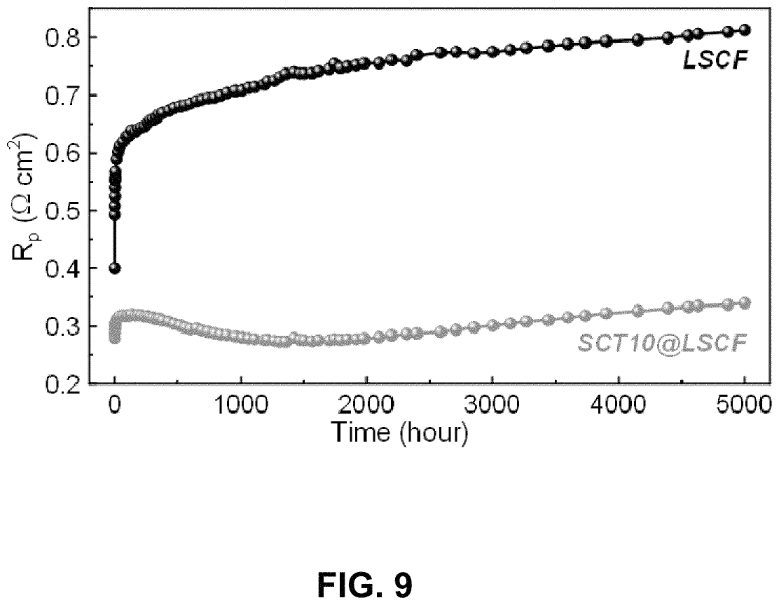

Similarly, FIGS. 8A-8E show the effect of H₂O on Rp for the two oxygen electrodes at varying temperatures. Again, the bilayer oxygen electrode exhibits a better tolerance to H₂O than the pristine one.

Stability test on symmetrical cells

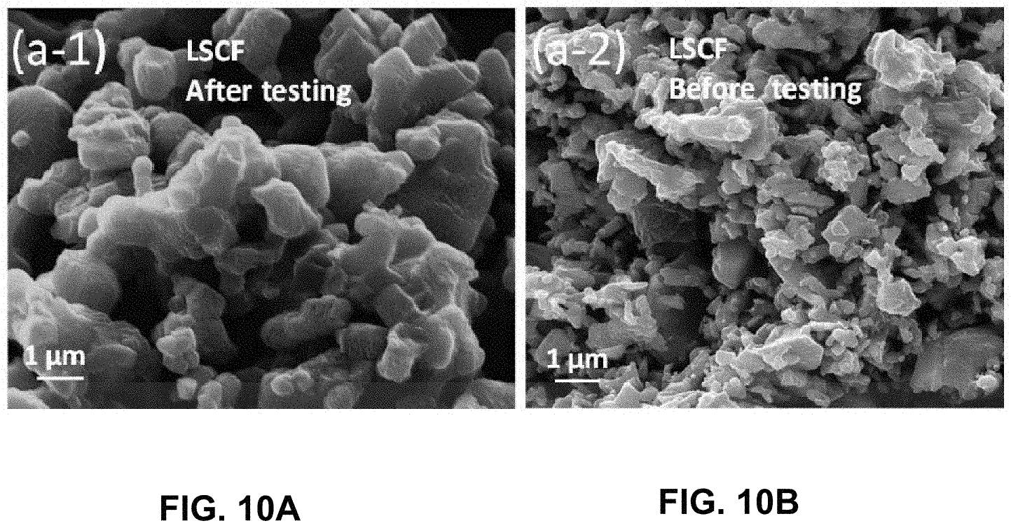

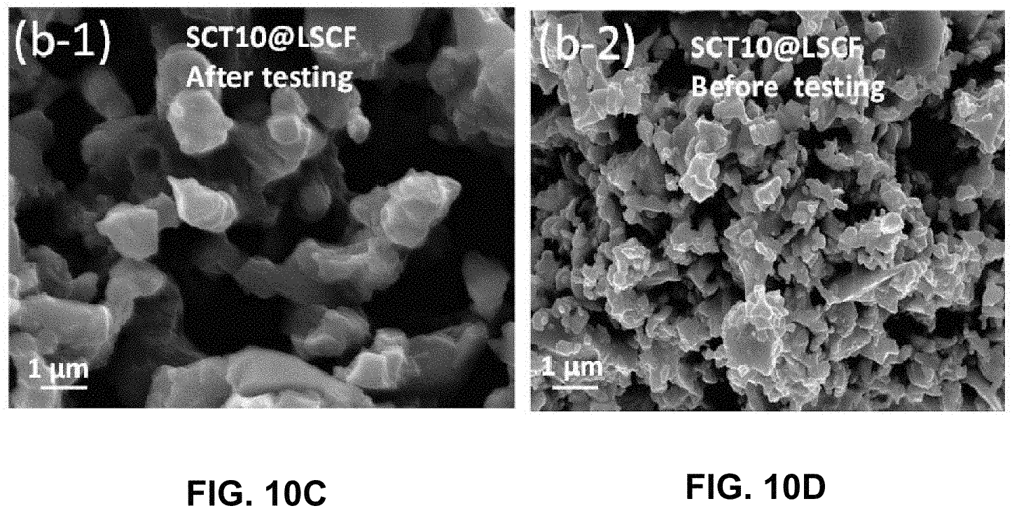

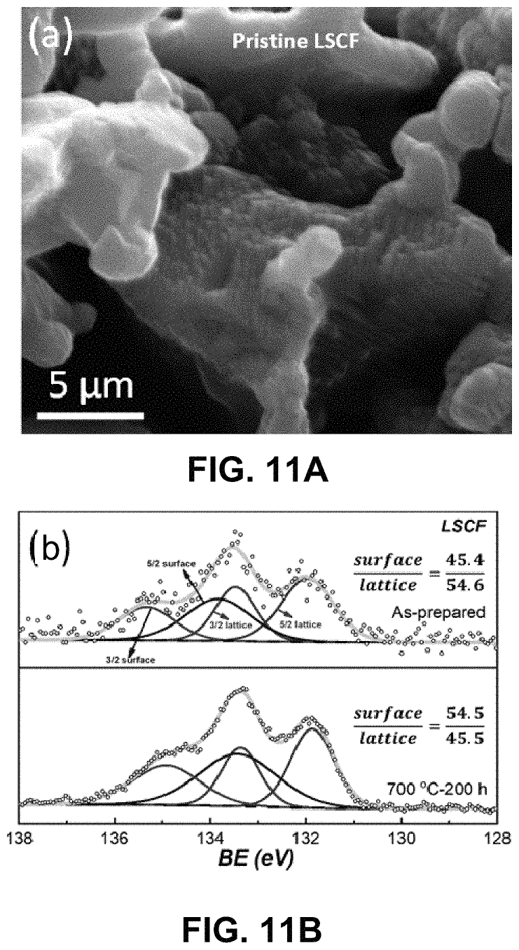

One foreseeable advantage of the iso-structural SCT10@LSCF oxygen electrode is the inherent long-term stability enabled by its coarsening-limiting conformality and absence of Sr-segregation. To test this hypothesis, we performed a side-by-side, long-term stability evaluation on symmetrical cells containing both SCT10@LSCF and pristine LSCF oxygen electrodes at 700° C.; the results are shown in FIG. 9. Evidently, the polarization resistance of the pristine LSCF, Rp, doubles from 0.40 to 0.81 Ω cm² over 5,000 hours. The microstructure of the post-tested pristine LSCF oxygen electrode shown in FIG. 10A indicates an increased particle size in comparison to its original morphology, shown in FIG. 10B, which suggests that particle coarsening is one of the causes for the degradation. In contrast, FIG. 9 shows that SCT10@LSCF oxygen electrode only experienced 21% increase (from 0.28 to 0.34 Ω cm²) in Rₚ after 5,000 hours. The SEM analysis shown in FIGS. 10C and 10D suggests a lesser particle agglomeration than the pristine LSCF after long-term testing at 700° C.

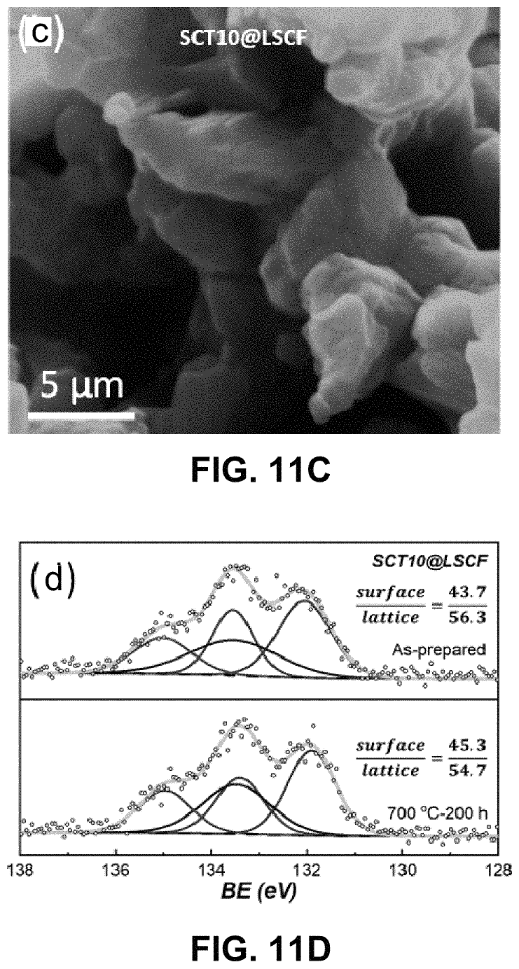

Another source of degradation for the pristine LSCF cell is the well-documented surface Sr-segregation. The morphology of the post-tested samples in FIG. 11A shows a sign of segregated Sr-species in the pristine LSCF (rough surface), but not in FIG. 11C, which shows SCT10@LSCF after the 5,000-hour testing. To further verify the SEM observation, XPS was performed on a sister-set of the samples annealed at 700° C. for only 200 hours to examine the surface Sr-concentration. The logic is that there will be more pronounced Sr-segregation for the sample after being tested for 5,000 hours if the sample treated at 700° C. for 200 hours exhibits Sr-segregation. FIG. 11B shows Sr-3d XPS spectrum of the pristine LSCF sample, indicating that the ratio of (surface-Sr)/(lattice-Sr) increases from 45.4/54.6 to 54.5/45.5 after the treatment. In contrast, FIG. 11D of Sr-3d XPS spectrum of SCT10@LSCF shows an almost constant ratio for the same treatment. These results suggest that the SCT10@LSCF has a much better resistance to the Sr-segregation than LSCF, which also indirectly confirms that Sr′_{Lα}-Vₒ^{••} interaction is the root cause for the surface Sr-segregation. The excellent stability and low R_{P} of SCT10@LSCF are rooted in simultaneous suppression in coarsening and Sr-segregation, and further suggest that the isostructural bilayer design is a promising strategy for commercially viable IT-oxygen electrodes in the future.

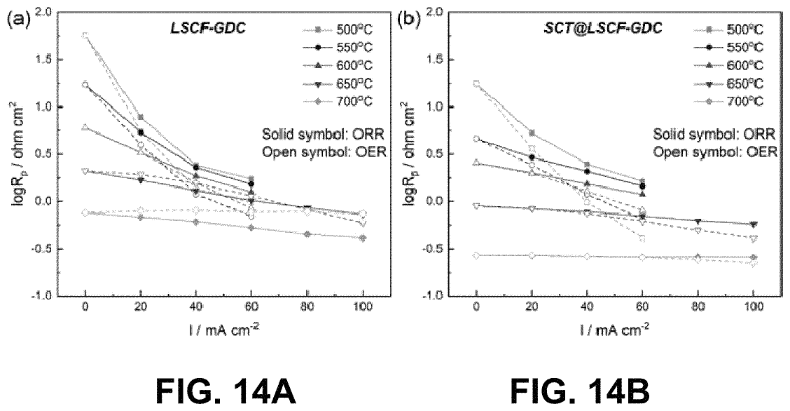

To understand how well the bilayer OE will work under load, EIS analysis was conducted using a symmetrical cell configuration, but with a three-electrode configuration as shown in FIG. 13. FIGS. 14A and 14B display graphs showing R_{P} vs current density under both OER and ORR polarizations for the two OEs. As expected for any type of electrochemical cell, application of DC current will decrease Rₚ if charge-transfer (including adsorption and dissociation of active species) is the rate-limiting step. The results appear to demonstrate that DC current, whether in OER or ORR mode, has a more pronounced effect on Rₚ at lower temperatures than at higher temperatures, implying that charge-transfer is likely to be the rate-limiting step at lower temperatures. At higher temperatures, where the charge-transfer process is effectively activated, DC current would have less effect, which is exactly observed. Both OER-Rₚ and ORR-Rₚ are much lower for SCT@LSCF-GDC than LSCF-GDC over the temperature and current density range studied. It is also interesting to mention that the bilayer OE performs better in OER than ORR at high current densities and temperatures regimes, compared to the pristine sample.

1. A method of forming a fuel cell oxygen electrode, the method comprising:
preparing a solution containing: a strontium salt, a cobalt salt, and a tantalum compound;
applying a portion of the solution to a base electrode; and
calcining the base electrode after applying the buffer solution at a temperature of about 900° C. to about 1500° C.

2. The method of claim 1, wherein preparing the solution comprising the strontium salt, the cobalt salt, and the tantalum compound comprises:
preparing an aqueous solution comprising: the strontium salt, the cobalt salt, and water;
preparing a second solution comprising: the tantalum compound; and
combining the second solution with the aqueous solution.

3. The method of claim 1, wherein the base electrode comprises a support and an overcoat, and wherein the overcoat covers a region of the support.

4. The method of claim 3, wherein the overcoat is porous;

5. The method of claim 3, wherein the overcoat comprises La_{0.6}Sr_{0.4}Co_{0.2}Fe_{0.8}O_{3-δ}.

6. The method of claim 5, further comprising:
applying the overcoat to the surface of the support by screen printing.

7. The method of claim 1, wherein the base electrode comprises strontium.

8. The method of claim 7, wherein the base electrode further comprises lanthanum, cobalt, iron, or a combination thereof.

9. The method of claim 1, wherein the temperature is about 950° C. to about 1500° C.

10. The method of claim 9, wherein the temperature is about 975° C. to about 1250° C.

11. The method of claim 9, wherein the temperature is about 990° C. to about 1100° C.

12. The method of claim 1, further comprising modifying the solution by introducing one or more buffers and/or a chelating agent to the solution to achieve a pH of about 6 to about 10.

13. A composition for an electrode coating, the composition comprising SrCoTaO.

14. The composition of claim 13, wherein the composition has the empirical formula SrCo_{0.9}Ta_{0.1}O_{3-δ}.

15. The composition of claim 13, wherein the electrode coating is present on a base electrode that includes Sr.

16. A fuel cell oxygen electrode having a bilayer isostructure, the fuel cell oxygen electrode comprising:
a base electrode; and
an electrode coating covering some or all of the base electrode.

17. The fuel cell oxygen electrode of claim 16, wherein the base electrode comprises strontium.

18. The fuel cell oxygen electrode of claim 16, wherein the base electrode has a surface comprising La_{0.6}Sr_{0.4}Co_{0.2}Fe_{0.8}O_{3-δ}, and wherein the coating conformally covers a substantial portion of the surface.

19. The fuel cell oxygen electrode of claim 16, wherein the electrode coating comprises SrCoTaO.

20. The fuel cell oxygen electrode of claim 16, wherein the electrode coating has the empirical formula SrCo_{0.9}Ta_{0.1}O_{3-δ}.
